(19) United States
(12) Patent Application Publication
(10) Pub. No.: US 2012/0259051 A1
(43) Pub. Date: Oct. 11, 2012

(54) RUBBER COMPOSITION FOR BEAD APEX AND PNEUMATIC TIRE

(76) Inventor: Tatsuya MIYAZAKI, Kobe-shi (JP)

(21) Appl. No.: 13/442,912

(22) Filed: Apr. 10, 2012

(30) Foreign Application Priority Data
Apr. 11, 2011 (JP) 2011-087331
Nov. 29, 2011 (JP) 2011-260892

(51) Int. Cl. C08K 3/22; C08K 3/30; C08K 5/09; C08K 3/04

(52) U.S. Cl. 524/322; 524/432; 524/418

(57) ABSTRACT

Provided is a rubber composition for a bead apex and a pneumatic tire which can provide good handling stability and enable suppression of reduction of this performance. The rubber composition for a bead apex includes a rubber component; a carbon black; zinc oxide; and an alkylphenol-sulfur chloride condensate, wherein the carbon black has a COAN of 75 to 130 ml/100 g and a BET specific surface area of 25 to 50 m²/g, and an amount of the carbon black is 55 to 80 parts by mass and an amount of the zinc oxide is 7 to 12 parts by mass, per 100 parts by mass of the rubber component.

### TECHNICAL FIELD

The present invention relates to a rubber composition for a bead apex and a pneumatic tire using the same.

### BACKGROUND ART

Nowadays, tires for passenger cars and motorbikes of which the performance has been increased are desired to have the ability to enable high-speed, safe driving. In order to achieve the ability, high handling stability is required.

One known method of increasing the handling stability is a method involving increasing the rubber hardness of the bead apex. The rubber hardness is known to be increased by resin crosslinking. The resin crosslinking, however, has a problem of reduction in handling stability because repeated strain during driving decreases the hardness due to heat and destroys the resin crosslinked structure.

Patent Document 1 teaches the use of a (modified) phenol resin, non-reactive phenol resin, and carbon black; however, the performance stability (repeatability) in terms of handling stability is desired to be further improved.

Patent Document 1: JP 2009-127041 A

### SUMMARY OF THE INVENTION

The present invention aims to provide a rubber composition for a bead apex and a pneumatic tire which provide good handling stability and enable suppression of reduction of this performance to solve the above problems.

One aspect of the present invention is a rubber composition for a bead apex, including a rubber component; a carbon black; zinc oxide; and an alkylphenol-sulfur chloride condensate, wherein the carbon black has a COAN of 75 to 130 ml/100 g and a BET specific surface area of 25 to 50 m²/g, and an amount of the carbon black is 55 to 80 parts by mass and an amount of the zinc oxide is 7 to 12 parts by mass, per 100 parts by mass of the rubber component.

It is preferable that the rubber composition further include a phenol resin and/or a modified phenol resin, and a total amount of the phenol resin and the modified phenol resin be 5 to 18 parts by mass per 100 parts by mass of the rubber component. The phenol resin is preferably a cresol resin.

The rubber composition preferably further includes stearic acid in an amount of not less than 2.1 parts by mass per 100 parts by mass of the rubber component.

It is preferable that the rubber component include butadiene rubber, and natural rubber and/or isoprene rubber, and an amount of the butadiene rubber in 100% by mass of the rubber component be 20 to 80% by mass.

The rubber composition preferably further includes sulfur in an amount of 4 to 8 parts by mass per 100 parts by mass of the rubber component.

Another aspect of the present invention is a pneumatic tire including a bead apex produced from the above rubber composition.

The present invention relates to a rubber composition for a bead apex which includes a rubber component, a certain carbon black, zinc oxide, and an alkylphenol-sulfur chloride condensate, and in which the amounts of the carbon black and the zinc oxide contained are set to respective given amounts. Such a rubber composition can provide good handling stability and enables suppression of reduction over time of this performance.

### BEST MODE FOR CARRYING OUT THE INVENTION

The rubber composition for a bead apex according to the present invention includes a rubber component; a carbon black; zinc oxide; and an alkylphenol-sulfur chloride condensate, wherein the carbon black has a COAN of 75 to 130 ml/100 g and a BET specific surface area of 25 to 50 m²/g, and an amount of the carbon black is 55 to 80 parts by mass and an amount of the zinc oxide is 7 to 12 parts by mass per 100 parts by mass of the rubber component.

The use of a given amount of a high structure carbon black having a certain COAN and a certain BET specific surface area and a given amount of zinc oxide for a rubber composition containing an alkylphenol-sulfur chloride condensate can result in excellent handling stability (e.g. steering response) and enables suppression of reduction of this performance. The use can also lead to good fuel economy and good processability.

By further using a phenol resin and/or a modified phenol resin, reduction in handling stability can be more effectively suppressed. The reason that such an effect can be achieved is not clear, but is probably that the use of the high structure carbon black in place of a conventionally used carbon black enlarges or hardens composite spheres formed from the (modified) phenol resin, carbon black, and rubber component.

Also, use of a butadiene rubber containing syndiotactic polybutadiene crystals for a rubber component results in even better handling stability and enables suppression of reduction of this performance because the syndiotactic crystal component enters the composite spheres to give high hardness to the composite spheres. The same effects can be further effectively provided by, for example, increasing the amount of the (modified) phenol resin or sulfur to increase the crosslink density, or decreasing the amount of oil.

Examples of rubbers that may be contained in the rubber component include diene rubbers such as natural rubber (NR), isoprene rubber (IR), butadiene rubber (BR), styrene butadiene rubber (SBR), acrylonitrile butadiene rubber (NBR), chloroprene rubber (CR) and butyl rubber (IIR). Among these, NR and IR are preferred in terms of tensile strength, heat build-up, curing rate, compatibility with carbon black (dispersibility), and processability. BR is preferred in terms of hardness, and SBR is preferred in terms of processability. Combination use of BR with NR and/or IR, and combination use of SBR with NR and/or IR are more preferred.

The BR is not particularly limited and examples thereof include BR with a high cis-content, and syndiotactic polybutadiene crystal-containing BR (SPB-containing BR). Among these, SPB-containing BR is preferred for good handling stability, good extrusion processability, good adhesion, and good fuel economy.

In the case that the rubber component includes SPB-containing BR, the SPB content of the SPB-containing BR is preferably not less than 8% by mass, and more preferably not less than 12% by mass. An SPB content of less than 8% by mass may result in an insufficient effect in improving the processability. The SPB content is preferably not more than 20% by mass, and more preferably not more than 18% by mass. An SPB content of more than 20% by mass tends to result in lower processability. The SPB content of SPB-containing BR is expressed as the boiling n-hexane-insoluble matter content.

Examples of the SBR include emulsion-polymerized styrene butadiene rubber (E-SBR) and solution-polymerized styrene butadiene rubber (S-SBR). Particularly, E-SBR is preferred because it provides good processability, allows good dispersion of carbon black and is suitably used even in a carbon black-rich composition.

The styrene content of SBR is preferably not less than 10% by mass, and more preferably not less than 20% by mass. A styrene content of less than 10% by mass may not lead to improvement in the processability and tends to result in an insufficient hardness. The styrene content is preferably not more than 40% by mass, and more preferably not more than 30% by mass. A styrene content of more than 40% by mass tends to result in a decrease in fuel economy.

The styrene content of SBR herein is calculated by ¹H-NMR measurement.

The total amount of NR and IR in 100% by mass of the rubber component is preferably not less than 10% by mass, and more preferably not less than 20% by mass. A total amount of NR and IR of less than 10% by mass may result in an insufficient tensile strength. The upper limit of the total amount may be 100% by mass but is preferably not more than 80% by mass, and more preferably not more than 75% by mass. A total amount of more than 80% by mass tends to result in an insufficient hardness, and lead to a fast curing rate so that the rubber composition is likely to scorch when extruded.

The amount of BR in 100% by mass of the rubber component is preferably not less than 20% by mass, and more preferably not less than 30% by mass. The amount is preferably not more than 80% by mass, and more preferably not more than 70% by mass.

The amount of SPB-containing BR in 100% by mass of the rubber component is preferably not less than 20% by mass, and more preferably not less than 30% by mass. The amount is preferably not more than 80% by mass, and more preferably not more than 70% by mass.

An amount of BR or SPB-containing BR of less than the lower limit may result in an insufficient hardness. An amount of more than the upper limit tends to result in an increased viscosity, poor dispersibility of carbon black and poor extrusion processability, and also tends to result in a decrease in fuel economy.

The amount of SBR in 100% by mass of the rubber component is preferably not less than 5% by mass, and more preferably not less than 20% by mass. An amount of SBR of less than 5% by mass may not lead to improvement in the processability and tends to result in an insufficient hardness. The amount is preferably not more than 80% by mass, and more preferably not more than 40% by mass. An amount of more than 80% by mass tends to result in a decrease in elongation at break and fuel economy.

The rubber composition of the present invention contains a given amount of a carbon black having a certain COAN and a certain BET specific surface area, and a given amount of zinc oxide.

The COAN of the carbon black is not less than 75 ml/100 g, preferably not less than 80 ml/100 g, and more preferably not less than 95 ml/100 g. A COAN of less than 75 ml/100 g tends to result in a decrease in handling stability, and the change over time in this performance tends to be large. The COAN is not more than 130 ml/100 g and is preferably not more than 120 ml/100 g. A COAN of more than 130 ml/100 g tends to result in a decrease in fuel economy, and also tends to lead to an increased viscosity of the rubber composition, thereby decreasing the dispersibility of the carbon black.

The COAN of carbon black herein is determined in accordance with ASTM D 3493. Here, the oil used is dibutyl phthalate (DBP).

The BET specific surface area of the carbon black is not less than 25 m²/g and is preferably not less than 35 m²/g. A BET specific surface area of less than 25 m²/g tends to result in a decrease in handling stability, and the change over time in this performance tends to be large. The BET specific surface area is not more than 50 m²/g and is preferably not more than 45 m²/g. A BET specific surface area of more than 50 m²/g tends to result in a decrease in fuel economy.

The BET specific surface area of carbon black herein is determined in accordance with ASTM D 6556.

The DBP oil absorption (OAN) of the carbon black is preferably not less than 100 ml/100 g, and more preferably not less than 150 ml/100 g. A DBP oil absorption of less than 100 ml/100 g tends to result in a decrease in fuel economy, and also tends to lead to an increased viscosity of the rubber composition, thereby decreasing the dispersibility of the carbon black. The DBP oil absorption is preferably not more than 250 ml/100 g, and more preferably not more than 200 ml/100 g. A DBP oil absorption of more than 250 ml/100 g may result in insufficient fuel economy.

The DBP oil absorption (OAN) of carbon black herein is determined in accordance with ASTM D 2414.

The carbon black can be produced by a conventionally known method such as the furnace process or channel process.

The amount of the carbon black is not less than 55 parts by mass, and preferably not less than 58 parts by mass, per 100 parts by mass of the rubber component. The amount is not more than 80 parts by mass, preferably not more than 75 parts by mass, and more preferably not more than 70 parts by mass, per 100 parts by mass of the rubber component. An amount in the above range leads to good handling stability and enables suppression of reduction of this performance. Further, good fuel economy and good extrusion processability can be achieved.

The zinc oxide is not particularly limited, and may be one widely used in the tire industry, such as zinc oxides #1 to #3.

The amount of zinc oxide is not less than 7 parts by mass, preferably not less than 8 parts by mass, and more preferably not less than 9 parts by mass, per 100 parts by mass of the rubber component. The amount is not more than 12 parts by mass, and preferably not more than 10 parts by mass. An amount in the above range leads to good handling stability and enables suppression of reduction of this performance. Further, good fuel economy and good extrusion processability can be achieved.

The rubber composition of the present invention contains an alkylphenol-sulfur chloride condensate. The alkylphenol-sulfur chloride condensate is not particularly limited, and is preferably a compound represented by the following formula (1) in terms of achieving less heat build-up and a good hardness.

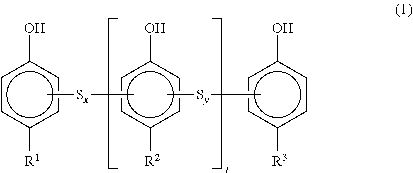

In formula (1), R¹, R², and R³ are the same as or different from each other, and each represent a C5 to C12 alkyl group; x and y are the same as or different from each other, and each represent an integer of 2 to 4; and t represents an integer of 0 to 250.

Here, t is preferably an integer of 0 to 100, more preferably of 10 to 100, and even more preferably of 20 to 50 in terms of good dispersibility of the alkylphenol-sulfur chloride condensate in the rubber component. In terms of efficient achievement of a high hardness, x and y are each preferably 2. R¹ to R³ are each preferably a C6 to C9 alkyl group in terms of good dispersibility of the alkylphenol-sulfur chloride condensate in the rubber component.

The alkylphenol-sulfur chloride condensate can be prepared by a known method such as a method involving reacting an alkylphenol and sulfur chloride at a molar ratio of 1:0.9-1.25, for example. Specific examples of the alkylphenol-sulfur chloride condensate include Tackirol V200 (represented by the following formula (2)) produced by Taoka Chemical Co., Ltd.

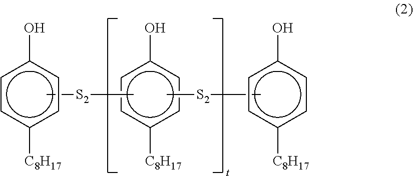

In the formula, t represents an integer of 0 to 100.

The amount of the alkylphenol-sulfur chloride condensate is preferably not less than 0.5 parts by mass, and more preferably not less than 1 part by mass, per 100 parts by mass of the rubber component. The amount is preferably not more than 6 parts by mass, and more preferably not more than 1.3 parts by mass. An amount in the above range leads to good handling stability and enables suppression of reduction of this performance. Further, good fuel economy and good extrusion processability can be achieved.

The rubber composition of the present invention preferably contains a phenol resin and/or a modified phenol resin. The use of such a component together with the rubber component, the alkylphenol-sulfur chloride condensate, and the given amounts of the certain carbon black and of the zinc oxide enables to achieve the effects of the present invention more significantly.

The term “phenol resin” is intended to include those obtained by the reaction between a phenol and an aldehyde such as formaldehyde, acetaldehyde or furfural in the presence of an acid or alkali catalyst. The term “modified phenol resin” is intended to include phenol resins modified with a compound such as cashew oil, tall oil, linseed oil, an animal or vegetable oil of any type, an unsaturated fatty acid, rosin, an alkylbenzene resin, aniline or melamine.

A modified phenol resin is preferred because larger composite spheres are formed, or harder composite spheres are formed owing to the sufficient hardness provided upon the curing reaction. In particular, a cashew oil-modified phenol resin or a rosin-modified phenol resin is more preferred.

Suitable examples of the cashew oil-modified phenol resin include those represented by the following formula (3).

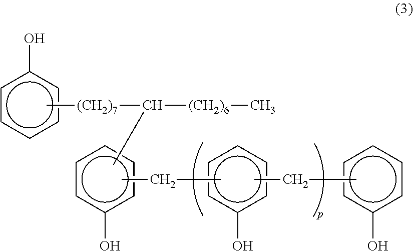

In formula (3), p is an integer of 1 to 9 and is preferably 5 or 6 for high reactivity and improved dispersibility.

The above phenol resin is suitably a cresol resin, and more suitably a cresol resin represented by the following formula.

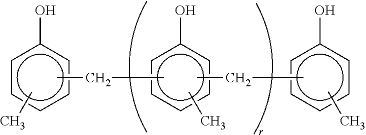

In the formula, r is an integer of 8 to 20, and preferably 12.

Specific examples of the cresol resin include PR-X11061 produced by Sumitomo Bakelite Co., Ltd.

The total amount of the phenol resin and the modified phenol resin is preferably not less than 5 parts by mass, and more preferably not less than 8 parts by mass, per 100 parts by mass of the rubber component. A total amount of less than 5 parts by mass may result in an insufficient hardness. The total amount is preferably not more than 18 parts by mass, and more preferably not more than 12 parts by mass, per 100 parts by mass of the rubber component. An amount of more than 18 parts by mass may result in insufficient fuel economy.

The rubber composition of the present invention preferably further includes a non-reactive alkylphenol resin. The non-reactive alkylphenol resin is highly compatible with the phenol resin and modified phenol resin and prevents the composite spheres from becoming soft, so that reduction in handling stability can be suppressed. In addition, good processability (in particular, adhesion) is provided. The term “non-reactive alkylphenol resin” is intended to refer to an alkylphenol resin free from reactive sites ortho and para (in particular, para) to the hydroxyl groups of the benzene rings in the chain. Suitable examples of the non-reactive alkylphenol resin include those represented by the following formulas (4) and (5).

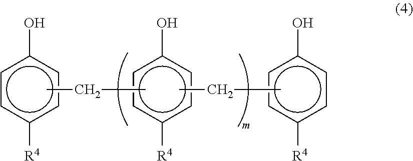

In formula (4), m is an integer, and is preferably an integer of 1 to 10, and more preferably of 2 to 9 for adequate blooming resistance. R⁴s may be the same as or different from each other, and each represent an alkyl group, preferably a C4 to C15 alkyl group, and more preferably a C6 to C10 alkyl group for compatibility with rubber.

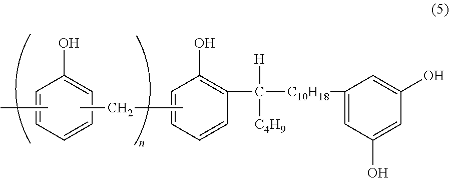

In formula (5), n is an integer, and is preferably an integer of 1 to 10, and more preferably of 2 to 9 for adequate blooming resistance.

The amount of the non-reactive alkylphenol resin is preferably not less than 0.2 parts by mass, and more preferably not less than 0.5 parts by mass, per 100 parts by mass of the rubber component. An amount of the non-reactive alkylphenol resin of less than 0.2 parts by mass tends to result in low adhesion. The amount is preferably not more than 7 parts by mass, and more preferably not more than 5 parts by mass, per 100 parts by mass of the rubber component. An amount of more than 7 parts by mass tends to lead to a decrease in fuel economy, hardness and E*.

The rubber composition of the present invention preferably contains a curing agent for curing a resin such as a phenol resin. The use of a curing agent results in formation of composite spheres in which a resin such as a phenol resin is crosslinked. As a result, the effects of the present invention are successfully provided. The curing agent is not particularly limited, provided that it has the curing ability mentioned above. Examples thereof include hexamethylenetetramine (HMT), hexamethoxymethylol melamine (HMMM), hexamethylol melamine pentamethyl ether (HMMPME), melamine and methylol melamine. Among these, HMT, HMMM and HMMPME are preferred because of their good ability to increase the hardness of a resin such as a phenol resin.

The lower limit of the amount of the curing agent is preferably not less than 1 part by mass, and more preferably not less than 5 parts by mass, per 100 parts by mass of the total amount of the phenol resin and the modified phenol resin. The upper limit thereof is preferably not more than 50 parts by mass, and more preferably not more than 15 parts by mass. An amount of the curing agent of less than the lower limit may not allow curing to sufficiently proceed; and an amount of more than the upper limit may not allow curing to uniformly proceed, and may result in scorch in the extrusion process.

The rubber composition of the present invention may contain silica. In this case, good adhesion is provided. The silica is not particularly limited and examples thereof include dry silica (silicic anhydride) and wet silica (hydrous silicic acid). Wet silica is preferred because it has more silanol groups.

The nitrogen adsorption specific surface area (N₂SA) of silica is preferably 70 to 220 m²/g. If the N₂SA is less than 70 m²/g, the silica may provide only a small reinforcing effect, presumably resulting in insufficient rubber strength. If the N₂SA is more than 220 m²/g, the silica tends to have low dispersibility and increase heat build-up.

The nitrogen adsorption specific surface area of silica herein is a value determined by the BET method in accordance with ASTM D 3037-81.

The amount of silica is preferably not more than 10 parts by mass, and more preferably not more than 5 parts by mass, per 100 parts by mass of the rubber component. The lower limit is not particularly limited. If the amount of silica is more than 10 parts by mass, the hardness tends to decrease, and the edge portion of the rubber extrudate after being assembled with the bead wires tends to bend (shrink) down with time. In this case, the rubber texture is slightly improved.

The rubber composition of the present invention may optionally contain compounding ingredients conventionally used in the rubber industry, in addition to the aforementioned ingredients. Examples of the compounding ingredients include oil, stearic acid, antioxidants of various types, sulfur, vulcanization accelerators, and retarders.

The rubber composition of the present invention typically contains sulfur. In terms of good handling stability, the amount of sulfur is preferably not less than 4 parts by mass, and more preferably not less than 5.5 parts by mass, per 100 parts by mass of the rubber component. The amount is preferably not more than 8 parts by mass, and more preferably not more than 6.5 parts by mass in terms of blooming of sulfur, adhesion and durability. The amount of sulfur herein refers to the amount of pure sulfur, and refers, in the case of insoluble sulfur, to the amount of sulfur excluding oil.

The rubber composition of the present invention preferably satisfies the relation of [amount of zinc oxide]/[amount of sulfur]>0.6. Such a rubber composition enables prevention of blooming of sulfur and shows good adhesion after extruded.

The rubber composition of the present invention may contain oil. Examples of the oil include process oils, vegetable oils and fats, and mixtures thereof. Examples of the process oils include paraffinic process oils, aromatic process oils, and naphthenic process oils. Examples of the vegetable oils and fats include castor oil, cottonseed oil, linseed oil, rapeseed oil, soybean oil, palm oil, coconut oil, peanut oil, rosin, pine oil, pine tar, tall oil, corn oil, rice oil, safflower oil, sesame oil, olive oil, sunflower oil, palm kernel oil, camellia oil, jojoba oil, macadamia nut oil, and tung oil.

In the case that the rubber composition contains oil, the amount of oil per 100 parts by mass of the rubber component is preferably not less than 1 part by mass, and more preferably not less than 2 parts by mass, but is preferably not more than 5 parts by mass, and more preferably not more than 4 parts by mass. An amount in the above range leads to a good hardness and good steering response.

The rubber composition of the present invention typically contains stearic acid. The amount of stearic acid per 100 parts by mass of the rubber component is preferably not less than 2.1 parts by mass, and more preferably not less than 2.5 parts by mass, but is preferably not more than 10 parts by mass, and more preferably not more than 4 parts by mass. An amount in the above range leads to a good hardness, good fuel economy, good processability, and good adhesion.

A known method can be employed as the method for producing the rubber composition of the present invention; for example, the rubber composition can be produced by mixing and kneading the ingredients mentioned above with use of a rubber kneader such as an open roll mill or a Banbury mixer, and then vulcanizing the mixture.

The rubber composition of the present invention is used for a bead apex that is a component placed on the inner side of a clinch of a tire and extending radially outwardly from a bead core. Specifically, the rubber composition is used, for example, for the components shown in FIGS. 1 to 3 of JP 2008-38140 A, and FIG. 1 of JP 2004-339287 A.

The pneumatic tire of the present invention can be produced by a usual method using the rubber composition. Specifically, before vulcanization, the rubber composition is extruded and processed into the shape of a bead apex, molded in a usual manner on a tire building machine, and then assembled with other tire components so as to form an unvulcanized tire. Then, the unvulcanized tire is heated and pressurized in a vulcanizer to produce a tire.

The pneumatic tire of the present invention is suitably used as a tire for motorcycles, a tire for SUVs, or the like, and is particularly suitably used as a tire for motorcycles.

### EXAMPLES

The present invention will be described in more detail based on examples which, however, are not intended to limit the scope of the present invention.

The various chemical agents used in examples and comparative examples are listed below.

NR: TSR20

BR: VCR617 produced by Ube Industries, Ltd. (SPB-containing BR, ML₁₊₄ (100° C.): 62, boiling n-hexane-insoluble matter content: 17% by mass)

SBR: Emulsion-polymerized SBR (E-SBR) 1502 produced by JSR Corporation (styrene content: 23.5% by mass)

Carbon black: see Table 1

Silica: Z115Gr produced by Rhodia

Alkylphenol resin: SP1068 produced by NIPPON SHOKUBAI Co., Ltd. (non-reactive alkylphenol resin represented by the above formula (4) in which m is an integer of 1 to 10 and R⁴ is an octyl group)

TDAE oil: Vivatec 500 produced by H&R

Antioxidant: Nocrac 6C (6PPD) produced by Ouchi Shinko Chemical Industrial Co., Ltd.

Stearic acid: Product of NOF Corporation

Zinc oxide: Product of Mitsui Mining & Smelting Co., Ltd.

Insoluble sulfur: CRYSTEX HS OT20 produced by FLEXSYS (insoluble sulfur containing 80% by mass of sulfur and 20% by mass of oil)

Vulcanization accelerator: Nocceler NS produced by Ouchi Shinko Chemical Industrial Co., Ltd. (N-tert-butyl-2-benzothiazolylsulfenamide)

CTP: N-cyclohexylthio-phthalamide (CTP) produced by Ouchi Shinko Chemical Industrial Co., Ltd.

Modified phenol resin: PR12686 produced by Sumitomo Bakelite Co., Ltd. (cashew oil-modified phenol resin represented by the above formula (3))

HMT (curing agent): Nocceler H produced by Ouchi Shinko Chemical Industrial Co., Ltd. (hexamethylenetetramine)

Tackirol V200: Tackirol V200 produced by Taoka Chemical Co., Ltd. (alkylphenol-sulfur chloride condensate represented by the above formula (2), sulfur content: 24% by mass)

TABLE 1

| | | | BET | |
|---|---|---|---|---|
| | | COAN | (NSA) | OAN |
| | | (ml/100 g) | (m²/g) | (ml/100 g) |
| Carbon | EB247 (Evonik Degussa) | 102 | 42 | 178 |
| black (1) | | | | |
| Carbon | Prototype (Mitsubishi | 112 | 38 | 185 |
| black (2) | Chemical Corp.) | | | |
| Carbon | N550 (Cabot Japan K.K.) | 78 | 42 | 115 |
| black (3) | | | | |
| Carbon | N550 (Jiangix Black Cat) | 88 | 40 | 126 |
| black (4) | | | | |
| Carbon | N351H (Mitsubishi | 102 | 68 | 137 |
| black (5) | Chemical Corp.) | | | |
| Carbon | N375 (Columbia Chemical) | 96 | 91 | 114 |
| black (6) | | | | |
| Carbon | N330 (Columbia Chemical) | 88 | 78 | 102 |
| black (7) | | | | |
| Carbon | N326 (Columbia Chemical) | 68 | 78 | 72 |
| black (8) | | | | |
| Carbon | N220 (Columbia Chemical) | 98 | 114 | 114 |
| black (9) | | | | |
| Carbon | N121 (Columbia Chemical) | 111 | 122 | 132 |
| black (10) | | | | |

### <Examples and Comparative Examples>

The materials in amounts shown in Tables 2 to 4, except the sulfur, vulcanization accelerator, CTP and curing agent, were kneaded in a 1.7-L Banbury mixer at 150° C. for five minutes such that a kneaded mixture was obtained. Thereafter, the sulfur, vulcanization accelerator, CTP and curing agent were added to the kneaded mixture and then the resulting mixture was kneaded with an open roll mill at 80° C. for three minutes to give an unvulcanized rubber composition. A portion of the unvulcanized rubber composition was press-vulcanized in a 2-mm-thick mold at 170° C. for 12 minutes to give a vulcanized rubber composition.

Another portion of the unvulcanized rubber composition was molded into the shape of a bead apex. The molded composition was assembled with other tire components into an unvulcanized tire and the tire was press-vulcanized at 170° C. for 12 minutes to give a tire for sport utility vehicles (SUV tire, size: P265/65R17 110S).

A set of SUV tires produced in this manner was mounted on an SUV (displacement: 3500 cc) and the vehicle was driven for break-in for about one hour on a test course of running mode with circuit, zigzag and circumference roads.

The obtained unvulcanized rubber compositions, vulcanized rubber compositions, and SUV tires (new ones and ones after break-in) were evaluated as follows. Tables 2 to 4 show the results.

### (Viscoelasticity Test)

The complex elastic modulus (E*) and loss tangent (tan 8) were measured for test samples prepared from the SUV tires using a viscoelasticity spectrometer VES (produced by Iwamoto Seisakusho Co., Ltd.) under the following conditions: a temperature of 70° C.; a frequency of 10 Hz; an initial strain of 10%; and a dynamic strain of 2%. A larger E* corresponds to higher rigidity and better handling stability. A smaller tan δ value corresponds to better fuel economy.

### (Handling Stability (Steering Response))

Each vehicle was driven on a dry asphalt test course (road surface temperature: 25° C.), and the handling stability (response of each vehicle to a minute change in the steering angle) during the driving was evaluated on a six-point scale based on sensory evaluation by a test driver. A higher point corresponds to better handling stability. The points “4+” and “5+” mean levels slightly higher than those of 4 and 5, respectively.

### (Rolling Resistance Test)

The rolling resistance was measured by a test in which the SUV tire (P265/65R17 110S, 17×7.5) was run on a drum under the following conditions: a temperature of 25° C.; a load of 4.9 N; a tire internal pressure of 2.00 kPa; and a speed of 80 km/hour. The rolling resistance of Comparative Example 1 is used as a reference and the rolling resistance of each composition is expressed as an index relative to the rolling resistance of Comparative Example 1 based on the following equation.

A larger index corresponds to more improved performance in terms of rolling resistance. (Rolling resistance ratio (%))=(rolling resistance of Comparative Example 1)/(rolling resistance of each composition)×100

TABLE 2

| | | | Example | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Components | NR | | 70 | 70 | 70 | 70 | 100 | 60 | 60 | 30 | 100 | 60 | 60 |
| (parts by mass) | BR | | — | — | — | — | — | 40 | 40 | 70 | — | 40 | 40 |
| | SBR | | 30 | 30 | 30 | 30 | — | — | — | — | — | — | — |
| | Carbon black (1) | | 60 | 60 | — | — | 60 | 60 | 56 | 56 | — | 56 | 56 |
| | Carbon black (2) | | — | — | 60 | 60 | — | — | — | — | 60 | — | — |
| | Carbon black (3) | | — | — | — | — | — | — | — | — | — | — | — |
| | Carbon black (4) | | — | — | — | — | — | — | — | — | — | — | — |
| | Carbon black (5) | | — | — | — | — | — | — | — | — | — | — | — |
| | Carbon black (6) | | — | — | — | — | — | — | — | — | — | — | — |
| | Carbon black (7) | | — | — | — | — | — | — | — | — | — | — | — |
| | Carbon black (8) | | — | — | — | — | — | — | — | — | — | — | — |
| | Carbon black (9) | | — | — | — | — | — | — | — | — | — | — | — |
| | Carbon black (10) | | — | — | — | — | — | — | — | — | — | — | — |
| | Silica | | — | — | — | — | — | — | — | — | — | — | — |
| | Alkyl phenol resin | | 3 | 1 | 3 | 1 | 1 | 1 | 1 | 1 | 1 | 1 | 1 |
| | TDAE oil | | — | — | — | — | — | — | — | — | — | — | 2 |
| | Antioxidant | | 1 | 1 | 1 | 1 | 1 | 1 | 1 | 1 | 1 | 1 | 1 |
| | Stearic acid | | 3 | 3 | 3 | 3 | 3 | 3 | 3 | 3 | 3 | 3 | 3 |
| | Zinc oxide | | 9 | 9 | 9 | 9 | 9 | 9 | 9 | 9 | 9 | 9 | 9 |
| | Insoluble sulfur | | 7.5 | 7.5 | 7.5 | 7.5 | 7.5 | 7.5 | 7.5 | 7.5 | 7.5 | 7.5 | 7.5 |
| | (S content) | | (6) | (6) | (6) | (6) | (6) | (6) | (6) | (6) | (6) | (6) | (6) |
| | Vulcanization | | 3.7 | 3.7 | 3.7 | 3.7 | 3.7 | 3.7 | 3.7 | 3.7 | 3.7 | 3.7 | 3.7 |
| | accelerator | | | | | | | | | | | | |
| | CTP | | 0.4 | 0.4 | 0.4 | 0.4 | 0.4 | 0.4 | 0.4 | 0.4 | 0.4 | 0.4 | 0.4 |
| | Modified phenol | | 10 | 10 | 10 | 10 | 10 | 10 | 10 | 10 | 10 | 15 | 15 |
| | resin | | | | | | | | | | | | |
| | HMT | | 1 | 1 | 1 | 1 | 1 | 1 | 1 | 1 | 1 | 1.5 | 1.5 |
| | Tackirol V200 | | 1.2 | 1.2 | 1.2 | 1.2 | 1.2 | 1.2 | 1.2 | 1.2 | 1.2 | 1.2 | 1.2 |
| Evaluation | New | E* | 43 | 47 | 44 | 48 | 46 | 50 | 47 | 50 | 47 | 50 | 46 |
| | | Steering | 5 | 6 | 5+ | 6 | 6 | 6 | 6 | 6 | 6 | 6 | 6 |
| | | response | | | | | | | | | | | |
| | | tan δ 70° C. | 0.12 | 0.112 | 0.119 | 0.108 | 0.105 | 0.11 | 0.104 | 0.12 | 0.104 | 0.107 | 0.097 |
| | After | E* | 41 | 46 | 42 | 47 | 45 | 49 | 47 | 48 | 47 | 50 | 45 |
| | break-in | Steering | 4+ | 6 | 5+ | 6 | 6 | 6 | 6 | 5+ | 6 | 6 | 5+ |
| | | response | | | | | | | | | | | |

| | | | Example | | | | | | | | | | |
|---|---|---|---|---|---|---|---|---|---|---|---|---|---|
| | | | 12 | 13 | 14 | 15 | 16 | 17 | 18 | 19 | 20 | 21 | 22 |
| Components | NR | | 60 | 70 | 70 | 70 | 70 | 70 | 60 | 70 | 70 | 60 | 70 |
| (parts by mass) | BR | | 40 | — | — | — | — | — | 40 | — | — | 40 | — |
| | SBR | | — | 30 | 30 | 30 | 30 | 30 | — | 30 | 30 | — | 30 |
| | Carbon black (1) | | 66 | 70 | 70 | 60 | — | — | — | — | — | — | — |
| | Carbon black (2) | | — | — | — | — | — | — | — | — | — | — | — |
| | Carbon black (3) | | — | — | — | — | — | — | — | 70 | 70 | 70 | — |
| | Carbon black (4) | | — | — | — | — | 70 | 70 | 70 | — | — | — | 70 |
| | Carbon black (5) | | — | — | — | — | — | — | — | — | — | — | — |
| | Carbon black (6) | | — | — | — | — | — | — | — | — | — | — | — |
| | Carbon black (7) | | — | — | — | — | — | — | — | — | — | — | — |
| | Carbon black (8) | | — | — | — | — | — | — | — | — | — | — | — |
| | Carbon black (9) | | — | — | — | — | — | — | — | — | — | — | — |
| | Carbon black (10) | | — | — | — | — | — | — | — | — | — | — | — |
| | Silica | | — | — | — | 5 | — | — | — | — | — | — | — |
| | Alkyl phenol resin | | 1 | 3 | 3 | 3 | 3 | 1 | 1 | 3 | 1 | 1 | 3 |
| | TDAE oil | | — | — | — | — | — | — | — | — | — | — | — |
| | Antioxidant | | 1 | 1 | 1 | 1 | 1 | 1 | 1 | 1 | 1 | 1 | 1 |
| | Stearic acid | | 3 | 3 | 3 | 3 | 3 | 3 | 3 | 3 | 3 | 3 | 2 |
| | Zinc oxide | | 9 | 9 | 8 | 9 | 9 | 9 | 9 | 9 | 9 | 9 | 9 |
| | Insoluble sulfur | | 7.5 | 7.5 | 5 | 7.5 | 7.5 | 7.5 | 7.5 | 7.5 | 7.5 | 7.5 | 7.5 |
| | (S content) | | (6) | (6) | (4) | (6) | (6) | (6) | (6) | (6) | (6) | (6) | (6) |
| | Vulcanization | | 3.7 | 3.7 | 3.7 | 3.7 | 3.7 | 3.7 | 3.7 | 3.7 | 3.7 | 3.7 | 3.7 |
| | accelerator | | | | | | | | | | | | |
| | CTP | | 0.4 | 0.4 | 0.4 | 0.4 | 0.4 | 0.4 | 0.4 | 0.4 | 0.4 | 0.4 | 0.4 |
| | Modified phenol | | 7 | 10 | 15 | 10 | 10 | 10 | 10 | 10 | 10 | 10 | 10 |
| | resin | | | | | | | | | | | | |
| | HMT | | 0.7 | 1 | 1.5 | 1 | 1 | 1 | 1 | 1 | 1 | 1 | 1 |
| | Tackirol V200 | | 1.2 | 1.2 | 1.2 | 1.2 | 1.2 | 1.2 | 1.2 | 1.2 | 1.2 | 1.2 | 1.2 |
| Evaluation | New | E* | 48 | 51 | 48 | 42 | 42 | 44 | 51 | 40 | 43 | 50 | 39 |
| | | Steering | 6 | 6 | 6 | 5 | 5 | 5+ | 6 | 5 | 5+ | 6 | 4+ |
| | | response | | | | | | | | | | | |
| | | tan δ 70° C. | 0.122 | 0.14 | 0.155 | 0.127 | 0.133 | 0.12 | 0.117 | 0.139 | 0.124 | 0.121 | 0.14 |
| | After | E* | 47 | 50 | 47 | 40 | 40 | 41 | 47 | 38 | 40 | 47 | 36 |
| | break-in | Steering | 6 | 6 | 6 | 4+ | 4+ | 4+ | 6 | 4+ | 4+ | 6 | 3+ |
| | | response | | | | | | | | | | | |

TABLE 3

| | | | Comparative Example | | | | | | | |
|---|---|---|---|---|---|---|---|---|---|---|
| | | | 1 | 2 | 3 | 4 | 5 | 6 | 7 | 8 |
| Components | NR | | 70 | 70 | 70 | 70 | 70 | 70 | 70 | 70 |
| (parts by mass) | BR | | — | — | — | — | — | — | — | — |
| | SBR | | 30 | 30 | 30 | 30 | 30 | 30 | 30 | 30 |
| | Carbon black (1) | | 60 | — | — | — | — | — | — | — |
| | Carbon black (2) | | — | — | — | — | — | — | — | — |
| | Carbon black (3) | | — | — | — | — | — | — | — | — |
| | Carbon black (4) | | — | 50 | — | — | — | — | — | — |
| | Carbon black (5) | | — | — | 60 | — | — | — | — | — |
| | Carbon black (6) | | — | — | — | 60 | — | — | — | — |
| | Carbon black (7) | | — | — | — | — | 60 | — | — | — |
| | Carbon black (8) | | — | — | — | — | — | 60 | — | — |
| | Carbon black (9) | | — | — | — | — | — | — | 60 | — |
| | Carbon black (10) | | — | — | — | — | — | — | — | 60 |
| | Silica | | — | — | — | — | — | — | — | — |
| | Alkyl phenol resin | | 3 | 3 | 3 | 3 | 3 | 3 | 3 | 3 |
| | TDAE oil | | — | — | — | — | — | — | — | — |
| | Antioxidant | | 1 | 1 | 1 | 1 | 1 | 1 | 1 | 1 |
| | Stearic acid | | 3 | 3 | 3 | 3 | 3 | 3 | 3 | 3 |
| | Zinc oxide | | 6 | 9 | 9 | 9 | 9 | 9 | 9 | 9 |
| | Insoluble sulfur | | 7.5 | 7.5 | 7.5 | 7.5 | 7.5 | 7.5 | 7.5 | 7.5 |
| | (S content) | | (6) | (6) | (6) | (6) | (6) | (6) | (6) | (6) |
| | Vulcanization accelerator | | 3.7 | 3.7 | 3.7 | 3.7 | 3.7 | 3.7 | 3.7 | 3.7 |
| | CTP | | 0.4 | 0.4 | 0.4 | 0.4 | 0.4 | 0.4 | 0.4 | 0.4 |
| | Modified phenol resin | | 10 | 10 | 10 | 10 | 10 | 10 | 10 | 10 |
| | HMT | | 1 | 1 | 1 | 1 | 1 | 1 | 1 | 1 |
| | Tackirol V200 | | 1.2 | 1.2 | 1.2 | 1.2 | 1.2 | 1.2 | 1.2 | 1.2 |
| Evaluation | New | E* | 37 | 21 | 49 | 51 | 42 | 39 | 52 | 54 |
| | | Steering response | 4 | 2 | 6 | 6 | 5 | 4+ | 6 | 6 |
| | | tan δ 70° C. | 0.131 | 0.112 | 0.151 | 0.166 | 0.165 | 0.155 | 0.179 | 0.201 |
| | | Rolling resistance ratio (%) | 100 | 117 | 87 | 79 | 79 | 85 | 73 | 65 |
| | After break-in | E* | 33 | 16 | 45 | 47 | 36 | 35 | 46 | 44 |
| | | Steering response | 3 | 1 | 5 | 5 | 3+ | 3 | 5 | 4+ |

TABLE 4

| | | | | | | | | | | | | Comparative | |
|---|---|---|---|---|---|---|---|---|---|---|---|---|---|
| | | | Example | | | | | | | | | Example | |
| | | | 23 | 24 | 25 | 26 | 16 | 27 | 28 | 29 | 30 | 9 | 2 |
| Components | NR | | 70 | 70 | 70 | 70 | 70 | 70 | 70 | 70 | 70 | 70 | 70 |
| (parts by mass) | BR | | — | — | — | — | — | — | — | — | — | — | — |
| | SBR | | 30 | 30 | 30 | 30 | 30 | 30 | 30 | 30 | 30 | 30 | 30 |
| | Carbon black (1) | | — | — | — | — | — | — | — | — | — | — | — |
| | Carbon black (2) | | — | — | — | — | — | — | — | — | — | — | — |
| | Carbon black (3) | | — | — | — | — | — | — | — | — | — | — | — |
| | Carbon black (4) | | 55 | 55 | 55 | 70 | 70 | 70 | 80 | 80 | 80 | 50 | 50 |
| | Carbon black (5) | | — | — | — | — | — | — | — | — | — | — | — |
| | Carbon black (6) | | — | — | — | — | — | — | — | — | — | — | — |
| | Carbon black (7) | | — | — | — | — | — | — | — | — | — | — | — |
| | Carbon black (8) | | — | — | — | — | — | — | — | — | — | — | — |
| | Carbon black (9) | | — | — | — | — | — | — | — | — | — | — | — |
| | Carbon black (10) | | — | — | — | — | — | — | — | — | — | — | — |
| | Silica | | — | — | — | — | — | — | — | — | — | — | — |
| | Alkyl phenol resin | | 3 | 3 | 3 | 3 | 3 | 3 | 3 | 3 | 3 | 3 | 3 |
| | TDAE oil | | — | — | — | — | — | — | — | — | — | — | — |
| | Antioxidant | | 1 | 1 | 1 | 1 | 1 | 1 | 1 | 1 | 1 | 1 | 1 |
| | Stearic acid | | 3 | 3 | 3 | 3 | 3 | 3 | 3 | 3 | 3 | 3 | 3 |
| | Zinc oxide | | 7 | 9 | 12 | 7 | 9 | 12 | 7 | 9 | 12 | 7 | 9 |
| | Insoluble sulfur | | 7.5 | 7.5 | 7.5 | 7.5 | 7.5 | 7.5 | 7.5 | 7.5 | 7.5 | 7.5 | 7.5 |
| | (S content) | | (6) | (6) | (6) | (6) | (6) | (6) | (6) | (6) | (6) | (6) | (6) |
| | Vulcanization accelerator | | 3.7 | 3.7 | 3.7 | 3.7 | 3.7 | 3.7 | 3.7 | 3.7 | 3.7 | 3.7 | 3.7 |
| | CTP | | 0.4 | 0.4 | 0.4 | 0.4 | 0.4 | 0.4 | 0.4 | 0.4 | 0.4 | 0.4 | 0.4 |
| | Modified phenol resin | | 10 | 10 | 10 | 10 | 10 | 10 | 10 | 10 | 10 | 10 | 10 |
| | HMT | | 1 | 1 | 1 | 1 | 1 | 1 | 1 | 1 | 1 | 1 | 1 |
| | Tackirol V200 | | 1.2 | 1.2 | 1.2 | 1.2 | 1.2 | 1.2 | 1.2 | 1.2 | 1.2 | 1.2 | 1.2 |
| Evaluation | New | E* | 27 | 28 | 29 | 41 | 42 | 46 | 59 | 60 | 61 | 19 | 21 |
| | | Steering response | 3 | 3 | 3 | 5 | 5 | 6 | 6 | 6 | 6 | 2 | 2 |
| | | tan δ 70° C. | 0.117 | 0.115 | 0.113 | 0.136 | 0.133 | 0.126 | 0.155 | 0.153 | 0.151 | 0.114 | 0.112 |
| | | Rolling resistance | — | — | — | — | — | — | — | — | — | 115 | 117 |
| | | ratio (%) | | | | | | | | | | | |
| | After | E* | 23 | 24 | 25 | 39 | 40 | 44 | 56 | 55 | 56 | 14 | 16 |
| | break- | Steering response | 3+ | 3+ | 3+ | 4+ | 4+ | 5 | 6 | 6 | 6 | 1 | 1 |
| | in | | | | | | | | | | | | |

| | | | Comparative Example | | | | | | | | | |
|---|---|---|---|---|---|---|---|---|---|---|---|---|
| | | | 10 | 11 | 12 | 13 | 14 | 15 | 16 | 17 | 18 | 19 |
| Components | NR | | 70 | 70 | 70 | 70 | 70 | 70 | 70 | 70 | 70 | 70 |
| (parts by mass) | BR | | — | — | — | — | — | — | — | — | — | — |
| | SBR | | 30 | 30 | 30 | 30 | 30 | 30 | 30 | 30 | 30 | 30 |
| | Carbon black (1) | | — | — | — | — | — | — | — | — | — | — |
| | Carbon black (2) | | — | — | — | — | — | — | — | — | — | — |
| | Carbon black (3) | | — | — | — | — | — | — | — | — | — | — |
| | Carbon black (4) | | 50 | 55 | 55 | 70 | 70 | 80 | 80 | 100 | 100 | 100 |
| | Carbon black (5) | | — | — | — | — | — | — | — | — | — | — |
| | Carbon black (6) | | — | — | — | — | — | — | — | — | — | — |
| | Carbon black (7) | | — | — | — | — | — | — | — | — | — | — |
| | Carbon black (8) | | — | — | — | — | — | — | — | — | — | — |
| | Carbon black (9) | | — | — | — | — | — | — | — | — | — | — |
| | Carbon black (10) | | — | — | — | — | — | — | — | — | — | — |
| | Silica | | — | — | — | — | — | — | — | — | — | — |
| | Alkyl phenol resin | | 3 | 3 | 3 | 3 | 3 | 3 | 3 | 3 | 3 | 3 |
| | TDAE oil | | — | — | — | — | — | — | — | — | — | — |
| | Antioxidant | | 1 | 1 | 1 | 1 | 1 | 1 | 1 | 1 | 1 | 1 |
| | Stearic acid | | 3 | 3 | 3 | 3 | 3 | 3 | 3 | 3 | 3 | 3 |
| | Zinc oxide | | 12 | 6 | 15 | 6 | 15 | 6 | 15 | 7 | 9 | 12 |
| | Insoluble sulfur | | 7.5 | 7.5 | 7.5 | 7.5 | 7.5 | 7.5 | 7.5 | 7.5 | 7.5 | 7.5 |
| | (S content) | | (6) | (6) | (6) | (6) | (6) | (6) | (6) | (6) | (6) | (6) |
| | Vulcanization accelerator | | 3.7 | 3.7 | 3.7 | 3.7 | 3.7 | 3.7 | 3.7 | 3.7 | 3.7 | 3.7 |
| | CTP | | 0.4 | 0.4 | 0.4 | 0.4 | 0.4 | 0.4 | 0.4 | 0.4 | 0.4 | 0.4 |
| | Modified phenol resin | | 10 | 10 | 10 | 10 | 10 | 10 | 10 | 10 | 10 | 10 |
| | HMT | | 1 | 1 | 1 | 1 | 1 | 1 | 1 | 1 | 1 | 1 |
| | Tackirol V200 | | 1.2 | 1.2 | 1.2 | 1.2 | 1.2 | 1.2 | 1.2 | 1.2 | 1.2 | 1.2 |
| Evaluation | New | E* | 23 | 25 | 31 | 39 | 47 | 54 | 62 | — | — | — |
| | | Steering response | 3 | 3 | 3 | 5 | 6 | 5 | 6 | — | — | — |
| | | tan δ 70° C. | 0.110 | 0.125 | 0.119 | 0.140 | 0.131 | 0.160 | 0.155 | — | — | — |
| | | Rolling resistance | 119 | 105 | 110 | 94 | 100 | 82 | 85 | — | — | — |
| | | ratio (%) | | | | | | | | | | |
| | After | E* | 18 | 21 | 27 | 37 | 44 | 51 | 56 | — | — | — |
| | break- | Steering response | 2 | 3 | 3+ | 4+ | 5 | 6 | 6 | — | — | — |
| | in | | | | | | | | | | | |

Regarding the examples in which a given amount of a high structure carbon black and a given amount of zinc oxide were compounded in a rubber composition containing an alkylphenol-sulfur chloride condensate, good handling stability was achieved, and reduction in handling stability was suppressed. These effects were particularly favorably achieved in the examples in which SPB-containing BR was used together. In contrast, regarding the comparative examples in which the amount of the high structure carbon black or zinc oxide was beyond the range of the given amount, reduction in handling stability was not sufficiently suppressed. In Comparative Examples 17 to 19 in which the amount of the carbon black used was more than the given amount, the ingredients were not able to be kneaded together, and therefore a rubber composition could not be formed.

1. A rubber composition for a bead apex, comprising
a rubber component;
a carbon black;
zinc oxide; and
an alkylphenol-sulfur chloride condensate, wherein the carbon black has a COAN of 75 to 130 ml/100 g and a BET specific surface area of 25 to 50 m²/g, and
an amount of the carbon black is 55 to 80 parts by mass and an amount of the zinc oxide is 7 to 12 parts by mass, per 100 parts by mass of the rubber component.

2. The rubber composition for a bead apex according to claim 1, further comprising a phenol resin and/or a modified phenol resin,
wherein a total amount of the phenol resin and the modified phenol resin is 5 to 18 parts by mass per 100 parts by mass of the rubber component.

3. The rubber composition for a bead apex according to claim 2,
wherein the phenol resin is a cresol resin.

4. The rubber composition for a bead apex according to claim 1, further comprising stearic acid in an amount of not less than 2.1 parts by mass per 100 parts by mass of the rubber component.

5. The rubber composition for a bead apex according to claim 1,
wherein the rubber component includes butadiene rubber, and natural rubber and/or isoprene rubber, and
an amount of the butadiene rubber in 100% by mass of the rubber component is 20 to 80% by mass.

6. The rubber composition for a bead apex according to claim 1, further comprising sulfur in an amount of 4 to 8 parts by mass per 100 parts by mass of the rubber component.

7. A pneumatic tire comprising a bead apex produced from the rubber composition according to any one of claims 1 to 6.
